(19) United States
(12) Patent Application Publication
(10) Pub. No.: US 2013/0328934 A1
(43) Pub. Date: Dec. 12, 2013

(54) DISPLAY DEVICE AND CONTROL METHOD THEREOF

(71) Applicant: Seijun LIM, Seoul (KR)

(72) Inventor: Seijun LIM, Seoul (KR)

(21) Appl. No.: 13/546,835

(22) Filed: Jul. 11, 2012

(30) Foreign Application Priority Data
Jun. 11, 2012 (KR) 10-2012-0062142

(51) Int. Cl. G09G 5/34

(52) U.S. Cl. 345/650

(57) ABSTRACT

Disclosed are a display device and a control method thereof. The display device includes first and second display units each configured to output an image, a sensor unit configured to generate orientation state information by measuring relative positions and/or directions of the first and second display units and to generate position change information including a movement direction and movement distance of the first or second display unit by measuring whether the first or second display unit is changed in position, and a controller configured to detect a user command with respect to the first or second display unit using the orientation state information and the position change information, and to control the first or second display unit in response to the user command. The display device and the control method thereof provide an intuitive user interface configured to assist a user in more efficiently controlling a plurality of display units.

This application claims the benefit of Korean Patent Application No. 10-2012-0062142, filed on Jun. 11, 2012, which is hereby incorporated by reference as if fully set forth herein.

### BACKGROUND OF THE INVENTION

1. Field of the Invention

The present invention relates to a display device and a control method thereof, and more particularly to a display device, which includes two or more display units and is capable of controlling each display unit based on a change in the position of the corresponding display unit, and a control method thereof.

2. Discussion of the Related Art

In recent years, owing to the expansion of the display market and technical advances, various shapes of display devices and user interface technologies that assist a user in more conveniently using the display devices have been developed. Among them, a multi-display device, which constructs a large screen using two or more display units, has been developed and commercialized.

Generally, the multi-display device is configured such that a plurality of display units having small and medium sizes of screens is combined to output a large screen. The large screen obtained by the multi-display device may display a single combined image or different individual images.

The multi-display device may be constructed in various ways according to the number of display units to be combined, and the positions of the respective display units may be changed in various ways. In addition to the plurality of display units, the multi-display device includes connectors, such as hinges, to closely connect the display units to one another. This configuration allows the user to change the positions of the respective display units in various ways.

In the case of the multi-display device having the plurality of display units, it is important to ensure that the user can control the respective display units because the respective display units may serve to display different screens and execute different applications. Therefore, there is a need for user interface technologies to assist the user in more efficiently controlling the respective display units.

### SUMMARY OF THE INVENTION

Accordingly, the present invention is directed to a display device and a control method thereof that substantially obviate one or more problems due to limitations and disadvantages of the related art.

An object of the present invention is to provide a display device, which provides a user interface to assist a user in efficiently controlling each of a plurality of display units constituting a multi-display device, and a control method thereof.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a display device includes a first display unit and a second display unit each configured to output an image, a sensor unit which is configured to generate orientation state information by measuring at least one of relative positions and directions of the first display unit and the second display unit, and which is configured to generate position change information by measuring whether the first display unit or the second display unit is changed in position, wherein the position change information includes a movement direction and a movement distance of the first display unit or the second display unit, and a controller configured to detect a user command with respect to the first display unit or the second display unit using the orientation state information and the position change information, and control the first display unit or the second display unit in response to the user command.

The sensor unit may generate the orientation state information including whether or not the first display unit and the second display unit are folded to overlap each other.

The sensor unit may include a first sensor configured to generate the position change information of the first display unit by measuring the change in the position of the first display unit, and a second sensor configured to generate the position change information of the second display unit by measuring the change in the position of the second display unit.

The display device may further include a connector configured to attach the first display unit and the second display unit to each other such that the first display unit and the second display unit are movable in a state of being attached to each other.

The connector may displace the first display unit or the second display unit to an original position thereof when the position of the first display unit or the second display unit is changed.

The sensor unit may generate position change time information of the first display unit or the second unit by measuring time consumed for changing the position of the first display unit or the second display unit, and the controller may control the first display unit or the second display unit using the position change time information.

The controller may control the first display unit using the position change information of the first display unit, and may control the second display unit using the position change information of the second display unit.

The controller may detect a user command with respect to an application that is being displayed on the first display unit or the second display unit using the orientation state information and the position change information, and may input the user command corresponding to the orientation state information and the position change information to the application.

The controller may control the first display unit and the second display unit using the position change information of the first display unit or the second display unit when the first display unit and the second display unit are displaying the same application.

The controller may control the first display unit and the second display unit using the position change information of the first display unit and the second display unit when the first display unit and the second display unit are displaying the same application.

The controller may identify a target display unit, to which the user command is input, using the acceleration or tilt of the first display unit and the second display unit measured by the sensor unit.

In accordance with another aspect of the present invention, a control method of a display device, includes generating orientation state information by measuring at least one of relative positions and directions of the first display unit and the second display unit each configured to output an image, generating position change information by measuring whether the first display unit or the second display unit is changed in position, wherein the position change information includes a movement direction and a movement distance of the first display unit or the second display unit, and detecting a user command with respect to the first display unit or the second display unit using the orientation state information and the position change information, and controlling the first display unit or the second display unit in response to the user command.

The generation of the orientation state information may include generating orientation state information including whether or not the first display unit and the second display unit are folded to overlap each other.

The first display unit and the second display unit may be attached to each other, and may be movable respectively in a state of being attached to each other.

The first display unit or the second display unit, the position of which has been changed, may be displaced to an original position thereof.

The control method may further include generating position change time information of the first display unit or the second unit by measuring time consumed for changing the position of the first display unit or the second display unit, and the control of the display unit may include controlling the first display unit or the second display unit using the position change time information.

The control of the display unit may include controlling the first display unit using the position change information of the first display unit, and controlling the second display unit using the position change information of the second display unit.

The control of the display unit may include detecting a user command with respect to an application that is being displayed on the first display unit or the second display unit using the orientation state information and the position change information, and inputting the user command corresponding to the orientation state information and the position change information to the application.

The control of the display unit may include controlling the first display unit and the second display unit using the position change information of the first display unit or the second display unit when the first display unit and the second display unit are displaying the same application.

The control of the display unit may include controlling the first display unit and the second display unit using the position change information of the first display unit and the second display unit when the first display unit and the second display unit are displaying the same application.

The control of the display unit may include identifying a target display unit, to which the user command is input, using the acceleration or tilt of the first display unit and the second display unit.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view showing a display device according to an embodiment of the present invention;

FIG. 2 is a view showing movement directions of the display device according to the embodiment of the present invention;

FIG. 3 is a block diagram showing a configuration of the display device according to the embodiment of the present invention;

FIGS. 4 and 5 are views showing a user input to the display device according to a first embodiment of the present invention;

FIGS. 6 and 7 are views showing a user interface of the display device according to the first embodiment of the present invention;

FIGS. 8 and 9 are views showing a user input to the display device according to a second embodiment of the present invention;

FIGS. 10 and 11 are views showing a user interface of the display device according to the second embodiment of the present invention;

FIGS. 12 and 13 are views showing a user input to the display device according to a third embodiment of the present invention;

FIGS. 14 to 16 are views showing a user interface of the display device according to the third embodiment of the present invention;

FIGS. 17 and 18 are views showing a user input to the display device according to a fourth embodiment of the present invention;

FIGS. 19 and 20 are views showing a user interface of the display device according to the fourth embodiment of the present invention;

FIGS. 21 and 22 are views showing a method for identifying a target display unit, the position of which has been changed, of the display device according to the present invention; and

FIG. 23 is a flowchart of a method for controlling the display device according to an embodiment of the present invention.

### DETAILED DESCRIPTION OF THE INVENTION

Hereinafter, the embodiments of the present invention will be described in detail with reference to the attached drawings to allow those skilled in the art to easily implement the present invention. In the following description, for convenience of description, the same or similar elements are denoted by the same reference numerals.

Although the terms used in the present invention are selected, as much as possible, from general terms that are widely used at present. Also, in a particular case, terms that are arbitrarily selected by the applicant of the present invention may be used. In this case, the meanings of these terms may be described in corresponding description parts of the invention. Accordingly, it should be noted that the terms used herein should be construed based on practical meanings thereof and the whole content of this specification, rather than being simply construed based on names of the terms.

With respect to constituent elements used in the following description, suffixes “module” and “unit” are given or mingled with each other only in consideration of ease in the preparation of the specification, and do not have or serve as different meanings.

A display device that will be described herein may include all appliances that are able to output a screen, such as a cellular phone, smart phone, tablet, Personal Digital Assistant (PDA), Portable Multimedia Player (PMP), etc.

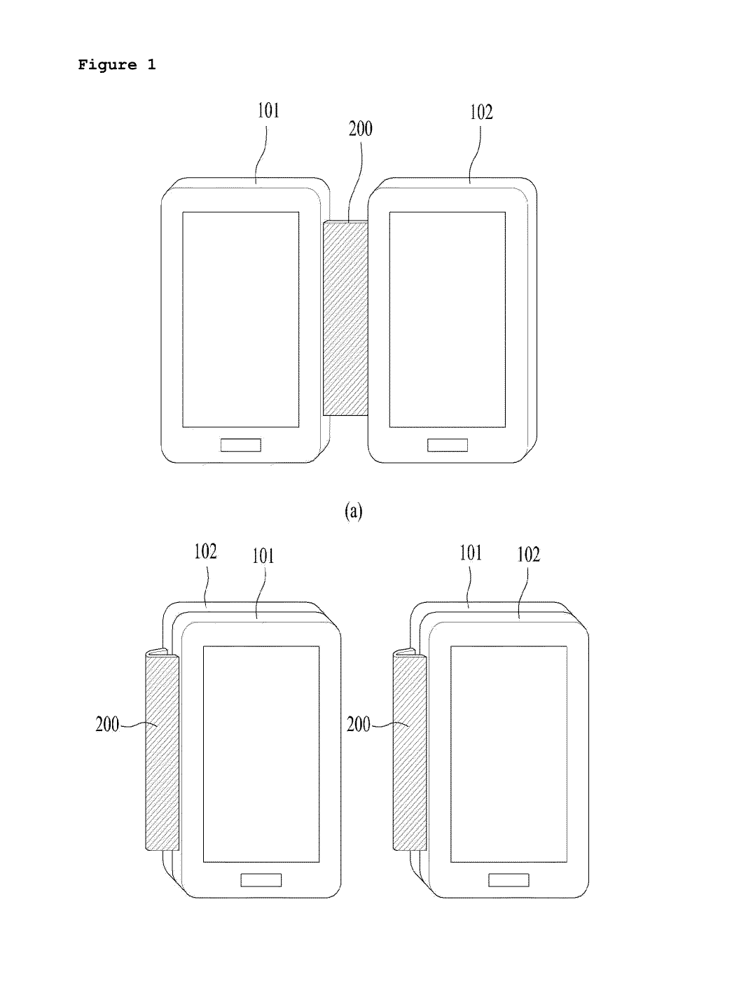

FIG. 1 is a view showing a display device 10 according to an embodiment of the present invention.

As shown, the display device 10 includes a first display unit 101, a second display unit 102, and a connector 200 to connect the two display units 101 and 102 to each other.

The display units 101 and 102 serve to output, e.g., a screen or image of an application that is executed on the display device 10. The respective display units 101 and 102 may output the same screen, or may output different screens. In addition, the two display units 101 and 102 may be combined to output a single large screen.

Although the drawing illustrates the display device 10 consisting of the two display units 101 and 102 by way of example, it will be clearly understood that the technical idea of the present invention is applicable even to other display devices having two or more display units.

The display units 101 and 102 include buttons to receive a user command. Of course, it will be understood that the display units 101 and 102 may be of a touchscreen type to receive a user command as a user directly touches the display units 101 and 102.

The connector 200 is used to connect and attach the first display unit 101 and the second display unit 102 to each other. The present invention includes various embodiments in which the connector 200 may employ various types of hinges, such as a foldable hinge, a sliding hinge, etc., capable of connecting the two display units 101 and 102 to each other.

In the present invention, the connector 200 is configured to change the positions of the first display unit 101 and the second display unit 102. That is, the first display unit 101 and the second display unit 102 are movable upward or downward and leftward or rightward, or are foldable to overlap each other in a state of being connected to each other. In one example, in the case in which the connector 200 is of a sliding hinge type, the respective display units 101 and 102 may slide upward or downward and leftward or rightward, or may be folded about the hinge so as to overlap each other. In this way, the user is able to change the position of the first display unit 101 or the second display unit 102.

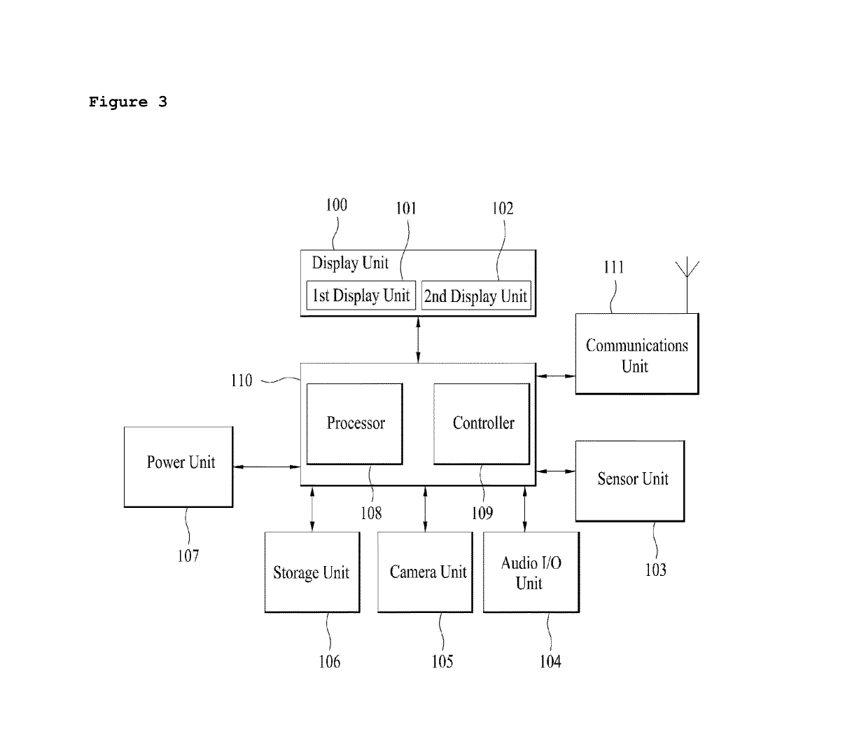

The connector 200 may include a sensor (not shown) to sense a change in the positions of the display units 101 and 102. This will hereinafter be described in detail with reference to FIG. 3.

Although the drawing illustrates the connector 200 as being attached to longitudinal lateral surfaces of the first display unit 101 and the second display unit 102 so as to connect the display units 101 and 102 to each other, the position of the connector 200 and the connection configuration of the first display unit 101 and the second display unit 102 are not limited thereto.

FIG. 1(a) shows the case in which the first display unit 101 and the second display unit 102 are unfolded from each other, and FIG. 1(b) shows the case in which the first display unit 101 and the second display unit 102 are folded to overlap each other. As shown in FIG. 1(b), in a state in which the display units 101 and 102 are folded to overlap each other, rear surfaces of the display units 101 and 102 face each other such that respective screens of the display units are exposed to the user.

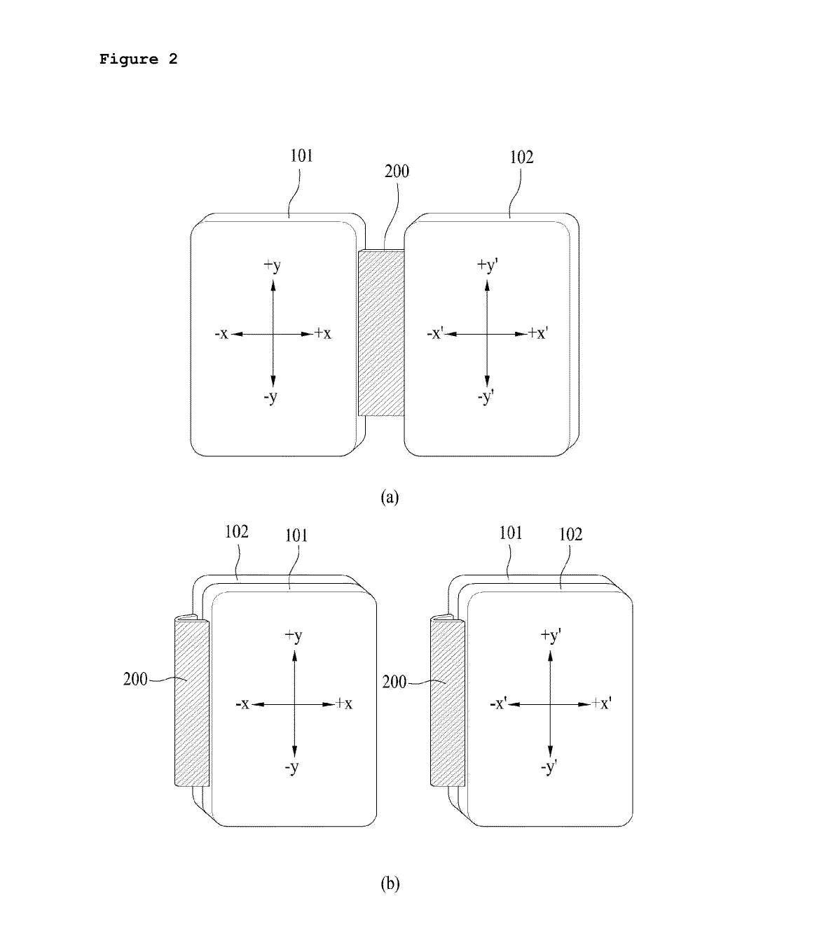

FIG. 2 is a view showing movement directions of the display units 101 and 102 according to the embodiment of the present invention.

As shown, the respective display units 101 and 102 are configured to move in upper and lower directions and in left and right directions. That is, the first display unit 101 and the second display unit 102 are movable in upper and lower directions and in left and right directions in a state of being connected to each other via the connector 200. In FIG. 2, the upper and lower directions and the left and right directions are represented respectively by +y and −y and by −x and +x. As such, the user is able to change the position of the first display unit 101 or the second display unit 102 in upper and lower directions and in left and right directions.

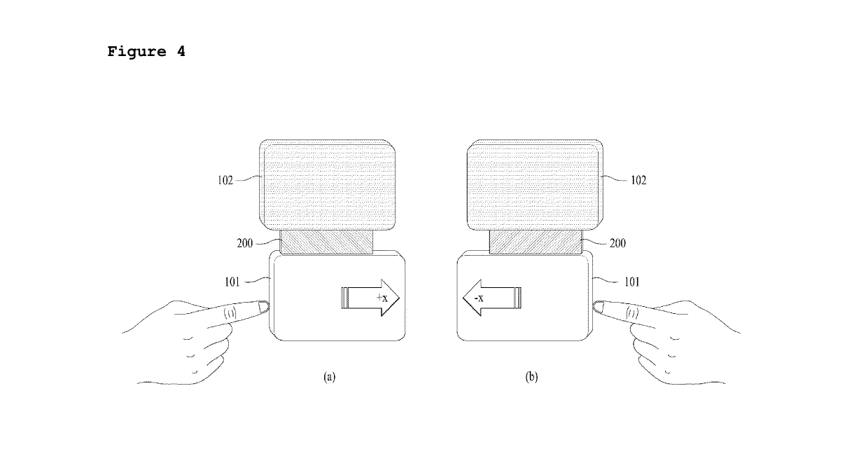

In the present invention, movement of the display units 101 and 102 by the user is input as a series of user commands. This will hereinafter be described in detail with reference to FIG. 4.

FIG. 2(a) shows the case in which the first display unit 101 and the second display unit 102 are unfolded from each other, and FIG. 2(b) shows the case in which the first display unit 101 and the second display unit 102 are folded to overlap each other. The respective display units 101 and 102 are movable independently.

Although the drawing illustrates the respective display units 101 and 102 as being movable only in upper and lower directions and in left and right directions, the present invention is not limited thereto. It will be clearly understood that the respective display units 101 and 102 are movable in an upper right direction +x+y, an upper left direction −x+y, a lower right direction +x−y, a lower left direction −x−y, or other directions within a range of 360 degrees.

FIG. 3 is a view showing a configuration of the display device 10 according to the embodiment of the present invention.

The display device 10 includes a display unit 100, a sensor unit 103, an audio input/output unit 104, a camera unit 105, a storage unit 106, a power unit 107, a processor 108, a controller 109, and a communications unit 111.

The display unit 100 includes the first display unit 101 and the second display unit 102. The respective display units 101 and 102 output images on screens thereof. The output images may include, for example, photographs, moving images, and application screens executed on the display device 10.

In the case in which the display units 101 and 102 are of a touchscreen type, the display unit 100 may detect a user touch input, and transmit the same to the controller 109. The display unit 100 may serve to output images on the display units 101 and 102, or to control the display units 101 and 102.

The sensor unit 103 may include a plurality of sensors mounted to the display device 10, and may serve to transmit a user input or environment recognized by the device 10 to the controller 109.

In one example, the plurality of sensors may include a gravity sensor, a geomagnetic sensor, a motion sensor, a gyro sensor, an acceleration sensor, an inclination sensor, a brightness sensor, a height sensor, an olfactory sensor, a temperature sensor, a depth sensor, a pressure sensor, a bending sensor, an audio sensor, a video sensor, a Global Positioning System (GPS), and a touch sensor.

The sensor unit 103 may measure the orientation state of the display units 101 and 102. For example, in the present invention, the gravity sensor or the gyro sensor may be used to measure whether the displays 101 and 102 are oriented vertically or horizontally, or whether or not the two displays 101 and 102 overlap each other. The sensor unit 103 may generate orientation state information corresponding to the measured orientation state of the display units 101 and 102.

Additionally, the sensor unit 103 may measure whether or not the positions of the display units 101 and 102 are changed. For example, in the present invention, the motion sensor or the acceleration sensor may be used to measure the movement direction and the movement distance of the first display unit 101 or the second display unit 102. The sensor unit 103 may generate position change information corresponding to the measured change in the position of the display unit 101 or 102.

The sensor unit 103 transmits the generated orientation state information and position change information of the display units 101 and 102 to the controller 109.

In an embodiment, the sensor unit 103 may include a first sensor, which measures whether or not the position of the first display unit 101 is changed and generates position change information of the first display unit 101, and a second sensor which measures whether or not the position of the second display unit 102 is changed and generates position change information of the second display unit 102.

The sensor unit 130 is a genetic term of the above described various sensors, and may measure a variety of user inputs and environmental information of the display device 10, and may transmit the sensed results to the controller 109 to allow the display device 10 to implement an operation based on the sensed results. The above described sensors may be provided as individual elements included in the display device 10, or may be combined to constitute at least one element included in the display device 10.

In the present invention, to efficiently measure whether or not the positions of the display units 101 and 102 are changed, the sensor unit 103 may be mounted within the above described connector 200.

The audio input/output unit 104 includes an audio output means, such as a speaker, etc., and an audio input means, such as a microphone, etc. The audio input/output unit 104 may implement audio output and input functions of the display device 10. The audio input/output unit 104 may be used as an audio sensor. In the display device 10 of the present invention, the audio input/output unit 104 may be selectively provided.

The camera unit 105 may take a photograph or a moving image, and may be selectively provided according to an embodiment. The camera unit 105 may include the above described motion sensor or a visual sensor to take a photograph or a moving image.

The storage unit 106 may store a variety of digital data, such as video, audio, photographs, applications, etc. The storage unit 106 denotes a variety of digital data storage spaces, such as a flash memory, a Hard Disk Drive (HDD), a Solid State Drive (SSD), etc. In the display device of the present invention, the storage unit 106 may be selectively provided.

The power unit 107 may be a battery within the display device 10 or a power source connected to an external power supply, and may supply power to the display device 10.

The processor 108 may execute a variety of video, audio, photographs, applications, etc. stored in the storage unit 106, and may process data within the display device 10.

The controller 109 may control the above described constituent elements of the display device 10, and may also control transmission and reception of data between the respective constituent elements.

The processor 108 and the controller 109 may constitute a single chip 110 to implement the above described respective operations simultaneously. In this case, the resulting structure may also be referred to as the controller 109 in the following description.

The controller 109 may generate a user command with respect to the display units 101 and 102 using the orientation state information and position change information of the corresponding display units 101 and 102 measured by the sensor unit 103, and may control the corresponding display units 101 and 102 based on the generated user command. This will hereinafter be described in detail.

The communications unit 111 may implement communications and transmission/reception of data with external devices of the display device 10 by means of various protocols. The communications unit 111 may be connected to an external network in a wired or wireless manner, so as to transmit and receive digital data.

FIG. 3 is a block diagram according to the embodiment of the present invention, in which individual blocks are given to logically divide the constituent elements of the display device 10. Accordingly, the above described constituent elements of the display device 10 may be mounted to a single chip or a plurality of chips based on device design.

As described above, in the present invention, the user may input a user command to the first display unit 101 or the second display unit 102 by moving the corresponding display unit 101 or 102. The display device 10 provides a variety of user interfaces using the input user command.

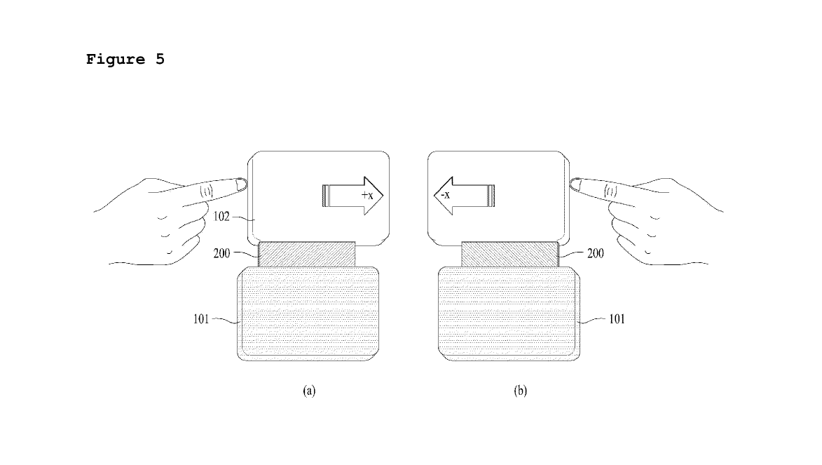

FIGS. 4 and 5 are views showing a user input to the display device 10 according to a first embodiment of the present invention.

According to the first embodiment of the present invention, in the case in which the display device 10 is vertically oriented, the user may input a user command by moving the first display unit 101 or the second display unit 102.

FIG. 4 illustrates the case in which the user inputs a user command by moving the first display unit 101. In this case, the second display unit 102 is kept stationary.

FIG. 5 illustrates the case in which the user inputs a user command by moving the second display unit 102. In this case, the first display unit 101 is kept stationary.

As shown in the drawings, the user is able to move the first display unit 101 or the second display unit 102 leftward or rightward using his/her hand. In this case, the display device 10 recognizes that a user command is input when the position of the display unit 101 or 102 is changed by manual operation of the user.

Although the drawing illustrates the first display unit 101 or the second display unit 102 as being moved leftward or rightward, it will be clearly understood that upward or downward movement, or movement in any other direction within 360 degrees of the display units 101 and 102 may be recognized as input of a user command.

First, as shown in the drawings, the display device 10 according to the first embodiment of the present invention is oriented vertically. In this case, the sensor unit 103 measures the vertical orientation of the display device 10, generates orientation state information corresponding to the measured result, and transmits the same to the controller 109. That is, the orientation state information is information that indicates whether the display device 10 is oriented vertically or horizontally, or whether both the display units 101 and 102 are folded to overlap each other.

Then, the user displaces the first display unit 101 or the second display unit 102. This displacement of the display unit 101 or 102 is sensed by the sensor unit 103. That is, the sensor unit 103 senses how much any one of the display units 101 and 102 is displaced in any direction. Then, the sensor unit 103 generates position change information of the corresponding display unit 101 or 102, and transmits the same to the controller 109.

The controller 109 provides a user interface of the corresponding display unit 101 or 102 using the generated orientation state information and position change information.

More specifically, the controller 109 generates a user command corresponding to the generated orientation state information and position change information. Then, the controller 109 operates an application that is being executed on the corresponding display unit 101 or 102 in response to the generated user command.

Here, the user interface may be configured in various ways by the application that is being executed on the corresponding display unit 101 or 102.

With regard to the above description, in the case in which the user moves any one display unit 101 or 102, the display device 10 of the present invention may be configured to return the corresponding display unit 101 or 102 to an original position thereof.

In this case, the sensor unit 103 may measure time consumed for the change in the position of the display unit 101 or 102, generate position change time information of the corresponding display unit 101 or 102, and transmit the same to the controller 109. The controller 109 may control the corresponding display unit 101 or 102 using the transmitted position change time information.

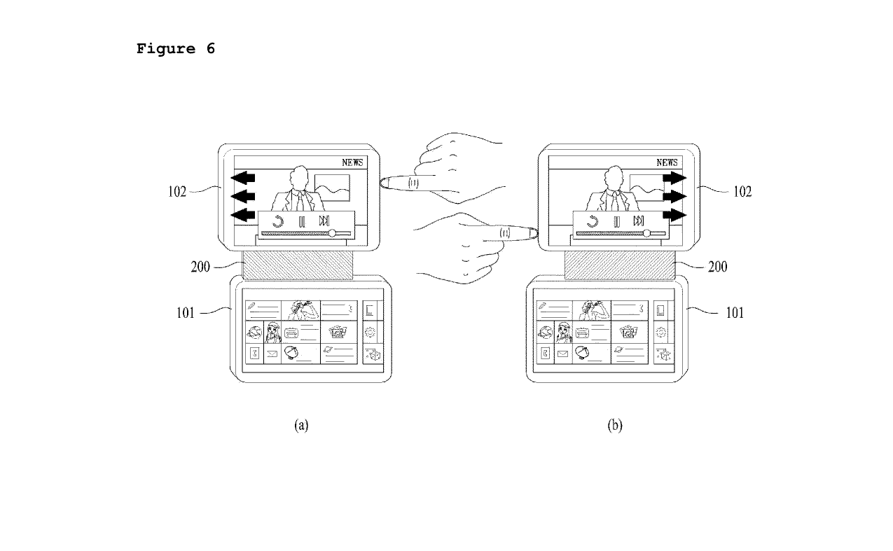

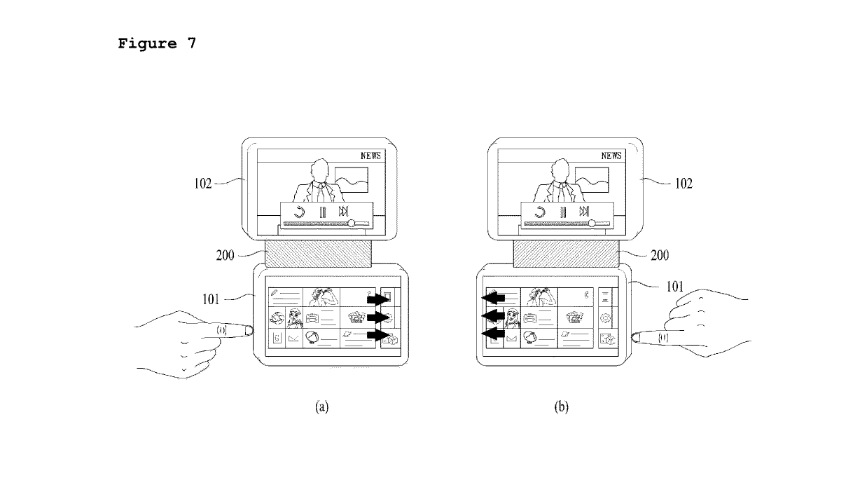

One example of realization of the user interface according to the first embodiment of the present invention will be described hereinafter with reference to FIGS. 6 and 7.

FIGS. 6 and 7 are views showing a user interface of the display device 10 according to the first embodiment of the present invention.

As shown in the drawings, the display device 10 is oriented vertically, the first display unit 101 is executing a menu application, and the second display unit 102 is executing a moving image application.

FIG. 6 shows the case in which the user changes the position of the second display unit 102.

As shown in FIG. 6(a), if the user moves the second display unit 102 leftward, the moving image application that is being executed on the second display unit 102 is rewound.

As shown in FIG. 6(b), if the user moves the second display unit 102 rightward, the moving image application that is being executed on the second display unit 102 is fast forwarded.

FIG. 7 shows the case in which the user changes the position of the first display unit 101.

As shown in FIG. 7(a), if the user moves the first display unit 102 rightward, the menu application that is being executed on the first display unit 101 moves displayed menus rightward.

As shown in FIG. 7(b), if the user moves the first display unit 101 leftward, the menu application that is being executed on the first display unit 101 moves the displayed menus leftward.

That is, the display device 10 generates a user command using the orientation state information indicating that the display device 10 is oriented vertically and the position change information indicating that the position of the display unit 101 or 102 has been changed by the user. The display device 10 operates the application that is being executed on the corresponding display unit 101 or 102 in response to the generated user command.

Also, the present invention may generate different user commands based on a displaced distance of the display unit 101 or 102. In one example, referring to FIG. 6, the moving image application may be rewound at 2× if the user moves the display unit 101 or 102 leftward by a predetermined distance or less, and may be rewound at 4× if the user moves the display unit 101 or 102 more than the predetermined distance.

In this way, the user is able to operate the application that is being executed on each display unit 101 or 102 via a simplified intuitive user input that moves the corresponding display unit 101 or 102.

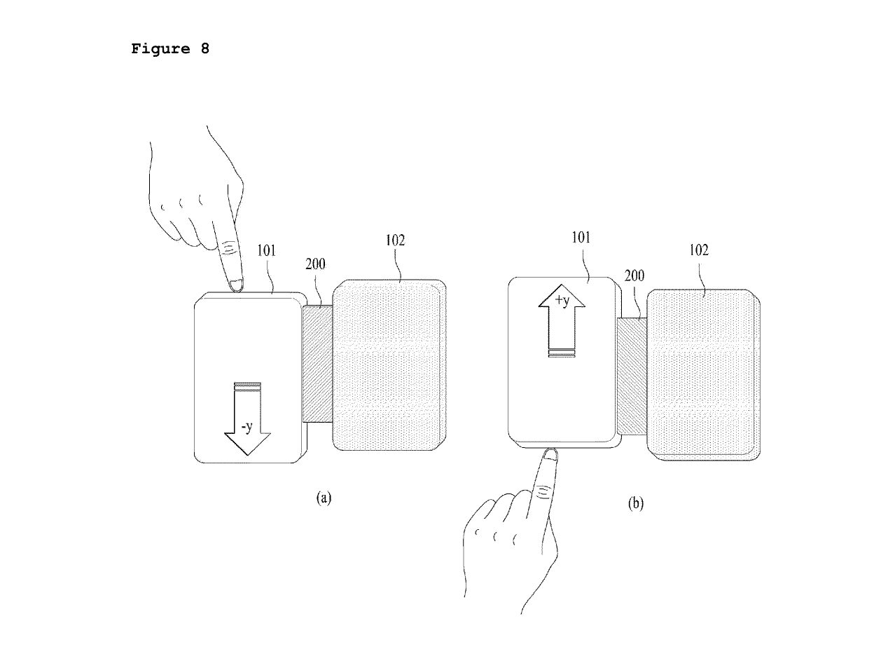

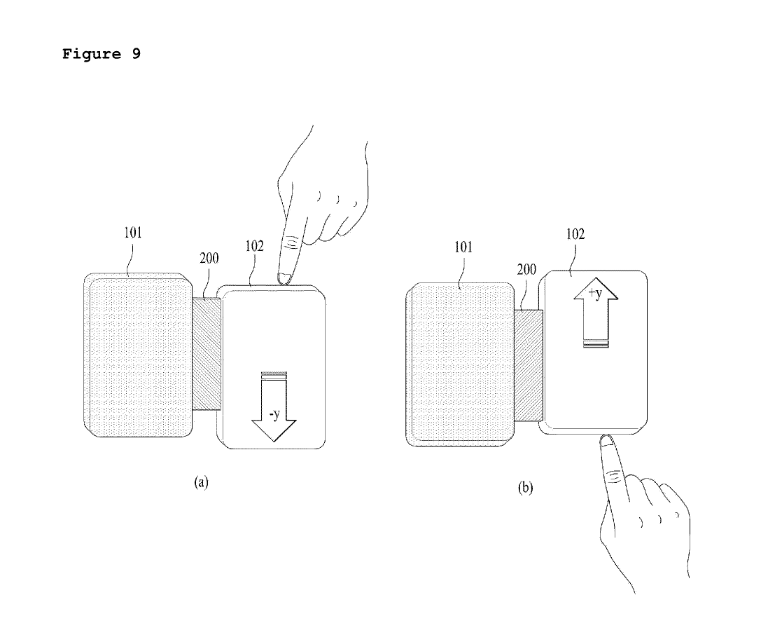

FIGS. 8 and 9 are views showing a user input to the display device 10 according to a second embodiment of the present invention.

According to the second embodiment of the present invention, in the case in which the display device 10 is oriented horizontally, the user may input a user command by moving the first display unit 101 or the second display unit 102.

FIG. 8 illustrates the case in which the user inputs a user command by moving the first display unit 101. In this case, the second display unit 102 is kept stationary.

FIG. 9 illustrates the case in which the user inputs a user command by moving the second display unit 102. In this case, the first display unit 101 is kept stationary.

As shown in the drawings, the user is able to move the first display unit 101 or the second display unit 102 upward or downward using his/her hand. In this case, the display device 10 recognizes that a user command is input when the position of the display unit 101 or 102 is changed by manual operation of the user.

Although the drawing illustrates the first display unit 101 or the second display unit 102 as being moved upward or downward, it will be clearly understood that the display units 101 and 102 are movable leftward or rightward, or in any other direction within 360 degrees.

First, as shown in the drawings, the display device according to the second embodiment of the present invention is oriented horizontally. In this case, the sensor unit 103 measures the horizontal orientation of the display device 10, generates orientation state information corresponding to the measured result, and transmits the same to the controller 109. As described above, the orientation state information is information that indicates whether the display device 10 is oriented vertically or horizontally, or whether both the display units 101 and 102 are folded to overlap each other.

Then, the user displaces the first display unit 101 or the second display unit 102. This displacement of the display unit 101 or 102 is sensed by the sensor unit 103. That is, the sensor unit 103 senses how much any one of the display units 101 and 102 is displaced in any direction. Then, the sensor unit 103 generates position change information of the corresponding display unit 101 or 102, and transmits the same to the controller 109.

The controller 109 provides a user interface of the corresponding display unit 101 or 102 using the generated orientation state information and position change information. More specifically, the controller 109 generates a user command corresponding to the generated orientation state information and position change information. Then, the controller 109 operates an application that is being executed on the corresponding display unit 101 or 102 in response to the generated user command.

Here, the user interface may be configured in various ways by the application that is being executed on the corresponding display unit 101 or 102.

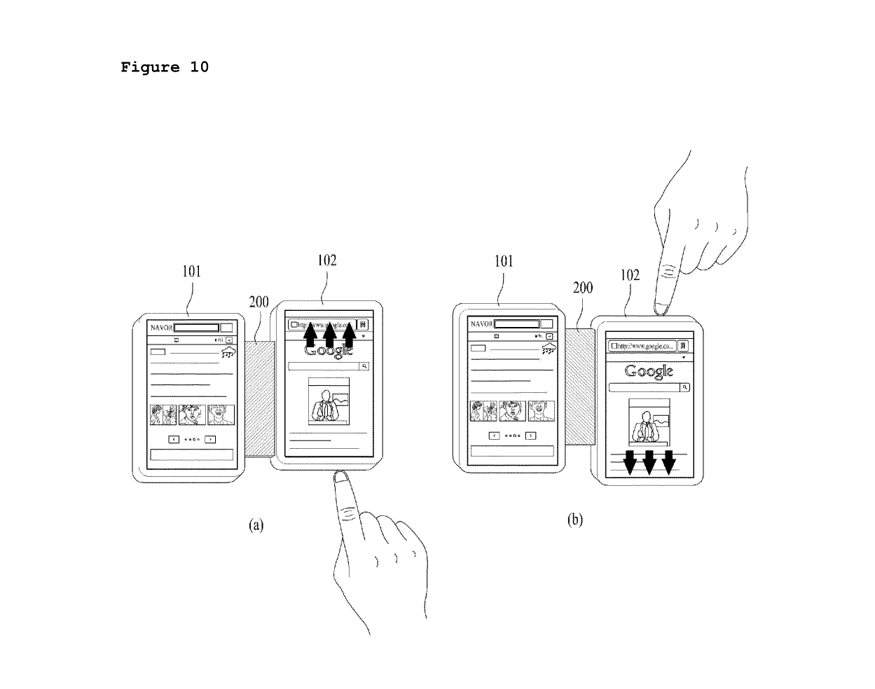

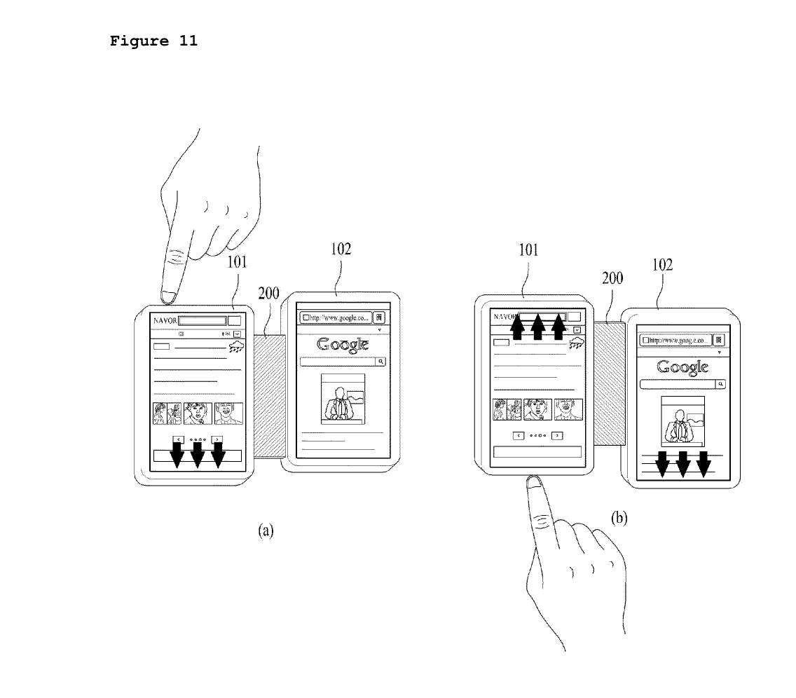

One example of realization of the user interface according to the second embodiment of the present invention will be described hereinafter with reference to FIGS. 10 and 11.

FIGS. 10 and 11 are views showing a user interface of the display device according to the second embodiment of the present invention.

As shown in the drawings, the display device 10 is oriented horizontally, and the first display unit 101 and the second display unit 102 are executing Internet applications.

FIG. 10 illustrates the case in which the user inputs changes the position of the second display unit 102.

As shown in FIG. 10(a), if the user moves the second display unit 102 upward, the Internet application that is being executed on the second display unit 102 moves a displayed Internet screen upward.

As shown in FIG. 10(b), if the user moves the second display unit 102 downward, the Internet application that is being executed on the second display unit 102 moves the displayed Internet screen downward.

FIG. 11 illustrates the case in which the user inputs changes the position of the first display unit 101.

As shown in FIG. 11(a), if the user moves the first display unit 101 downward, the Internet application that is being executed on the first display unit 101 moves a displayed Internet screen downward.

As shown in FIG. 11(b), if the user moves the first display unit 102 upward, the Internet application that is being executed on the first display unit 101 moves the displayed Internet screen upward.

That is, the display device 10 generates a user command using the orientation state information indicating that the display device 10 is oriented vertically and the position change information indicating that the position of the display unit 101 or 102 has been changed by the user. The display device 10 operates the application that is being executed on the corresponding display unit 101 or 102 in response to the generated user command.

When the user displaces the first display unit 101, only the application that is being executed on the first display unit 101 is operated. When the user displaces the second display unit 102, only the application that is being executed on the second display unit 102 is operated.

That is, in the present invention, the user is able to independently control the first display unit 101 and the second display unit 102.

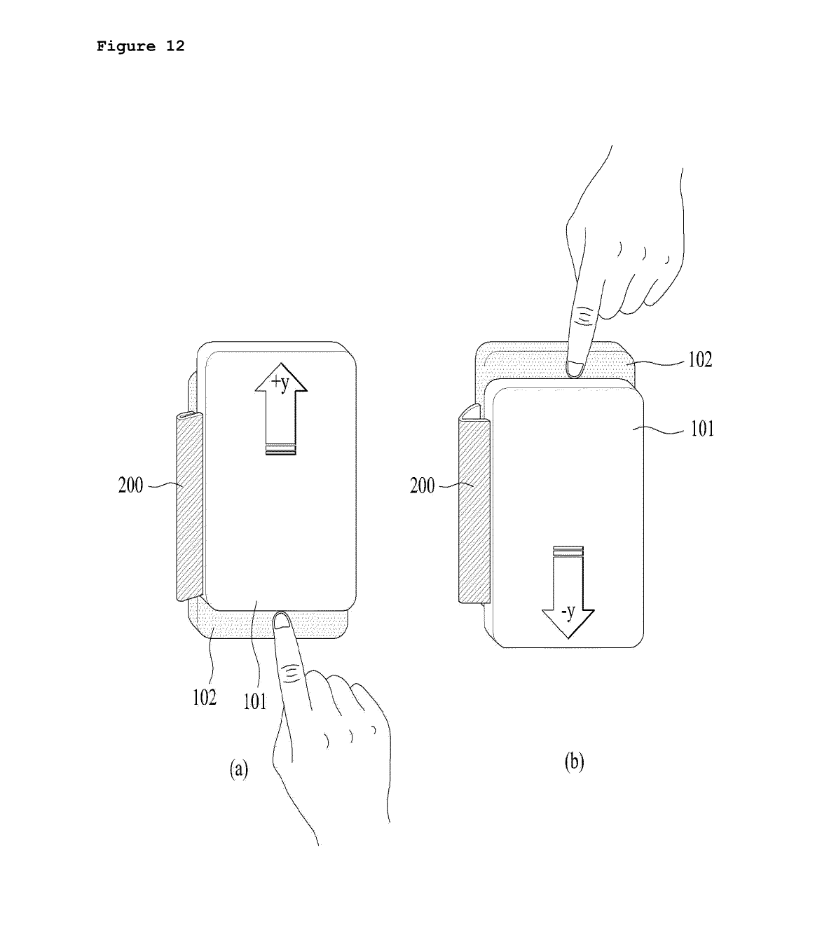

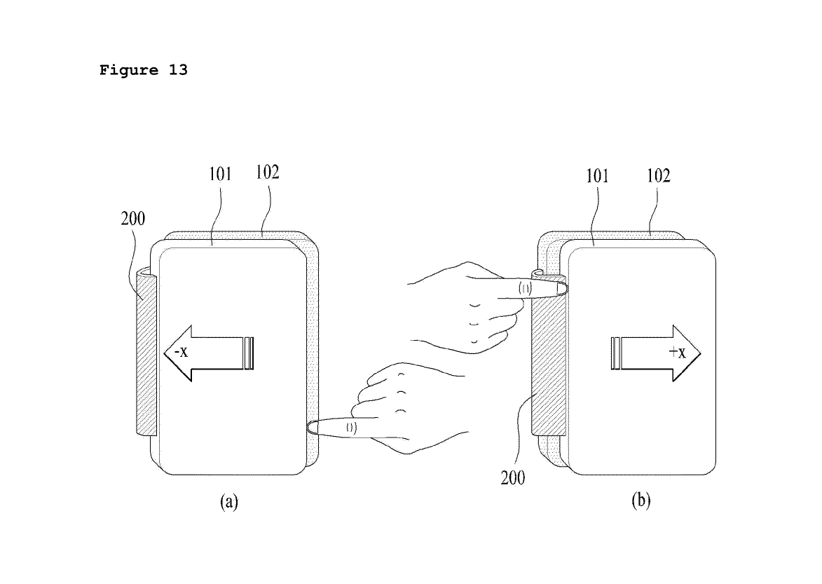

FIGS. 12 and 13 are views showing a user input to the display device according to a third embodiment of the present invention.

According to the third embodiment of the present invention, in the case in which the display units 101 and 102 are folded to overlap each other, the user is able to input a user command by moving the first display unit 101 or the second display unit 102. As shown in the drawings, in a state in which the display units 101 and 102 are folded to overlap each other, rear surfaces of the display units 101 and 102 face each other such that respective screens of the display units are exposed to the user. Accordingly, the user can see screens of the respective display units 101 and 102 even if the display units 101 and 102 overlap each other, and can control the respective display units 101 and 102.

FIGS. 12 and 13 illustrate the case in which the user inputs a user command by moving the first display unit 101. In this case, the second display unit 102 is kept stationary.

Similarly, the case in which the user inputs a user command by moving the second display unit 102, the first display unit 101 is kept stationary.

The user is able to move the first display unit 101 or the second display unit 102 upward or downward using his/her hand. In this case, the display device 10 recognizes that a user command is input when the position of the display unit 101 or 102 is changed by manual operation of the user.

Although the drawing illustrates the first display unit 101 as being moved upward or downward, it will be clearly understood that the user may move the second display unit 102, and may move the first display unit 101 or the second display unit 102 in any other direction within 360 degrees. As described above, movements of the respective display units 101 and 102 in various directions are recognized as input of a user command.

First, as shown in the drawings, the display device 10 according to the third embodiment of the present invention is oriented such that the display units 101 and 102 overlap each other. In this case, the sensor unit 103 measures the overlapping orientation of the display device 10, generates orientation state information corresponding to the measured result, and transmits the same to the controller 109. As described above, the orientation state information is information that indicates whether the display device 10 is oriented vertically or horizontally, or whether the display units 101 and 102 are folded to overlap each other.

Then, the user displaces the first display unit 101 or the second display unit 102. This displacement of the display unit 101 or 102 is sensed by the sensor unit 103. That is, the sensor unit 103 senses how much any one of the display units 101 and 102 is displaced in any direction. Then, the sensor unit 103 generates position change information of the corresponding display unit 101 or 102, and transmits the same to the controller 109.

The controller 109 provides a user interface of the corresponding display unit 101 or 102 using the generated orientation state information and position change information. More specifically, the controller 109 generates a user command corresponding to the generated orientation state information and position change information. Then, the controller 109 operates an application that is being executed on the corresponding display unit 101 or 102 in response to the generated user command.

Here, the user interface may be configured in various ways by the application that is being executed on the corresponding display unit 101 or 102.

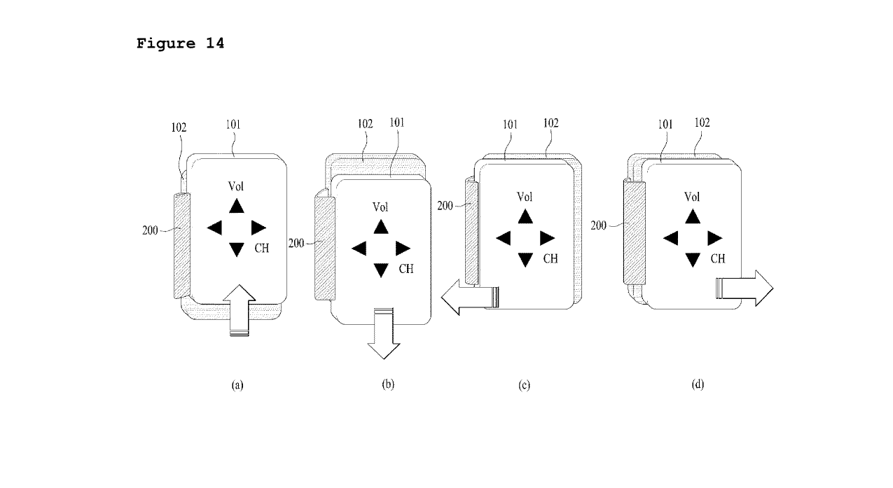

One example of realization of the user interface according to the third embodiment of the present invention will be described hereinafter with reference to FIGS. 14 to 16.

FIGS. 14 to 16 are views showing a user interface of the display device 10 according to the third embodiment of the present invention.

FIG. 14 shows the case in which the two display units 101 and 102 overlap each other, the first display unit 101 is executing a TV control application, and the user changes the position of the first display unit 101.

As shown in FIG. 14(a), if the user moves the first display unit 101 upward, the TV control application that is being executed on the first display unit 101 undergoes an operation of turning up the volume of a TV.

As shown in FIG. 14(b), if the user moves the first display unit 101 downward, the TV control application that is being executed on the first display unit 101 undergoes an operation of turning down the volume of a TV.

As shown in FIG. 14(c), if the user moves the first display unit 101 leftward, the TV control application that is being executed on the first display unit 101 undergoes an operation of turning down the channel of a TV.

As shown in FIG. 14(d), if the user moves the first display unit 101 rightward, the TV control application that is being executed on the first display unit 101 undergoes an operation of turning up the channel of a TV.

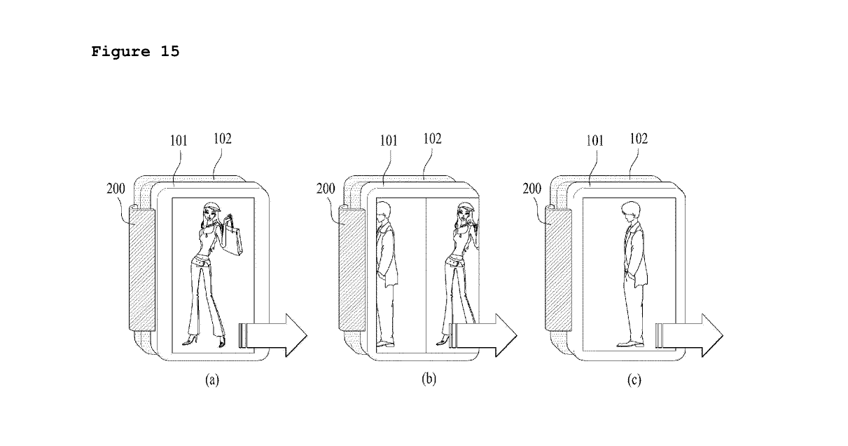

FIG. 15 shows the case in which the two display units 101 and 102 overlap each other, the first display unit 101 is executing an image output application, and the user changes the position of the first display unit 101.

As shown in FIGS. 15(a) to 15(c), if the user moves the first display unit 101 rightward, the image output application that is being executed on the first display unit 101 moves a current output image rightward.

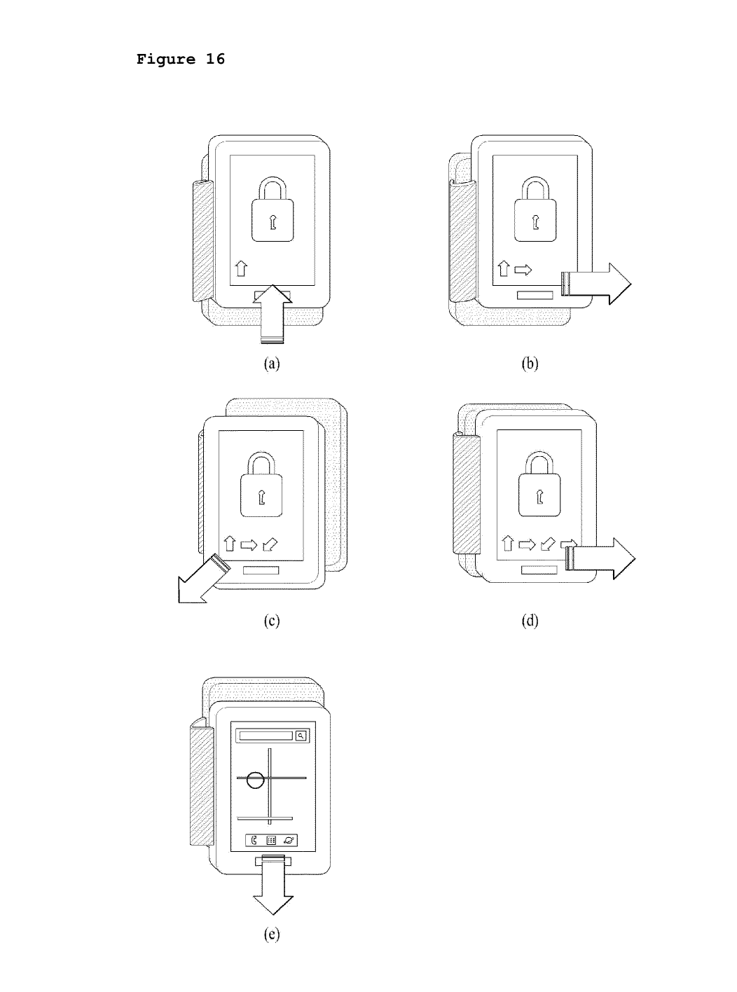

FIG. 16 shows the case in which the two display units 101 and 102 overlap each other, the first display unit 101 is executing a lock application, and the user changes the position of the first display unit 101.

As shown in FIGS. 16(a) to 16(e), if the user moves the first display unit 101 according to a preset pattern, the lock application that is being executed on the first display unit 101 releases the first display unit 101 from a locked state. FIG. 16(e) shows the unlocked first display unit 101.

That is, the display device 10 generates a user command using the orientation state information indicating that the display units 101 and 102 are oriented to overlap each other and the position change information indicating that the positions of the display units 101 and 102 have been changed by the user. The display device 10 operates the applications that are being executed on the display units 101 and 102 in response to the generated user command.

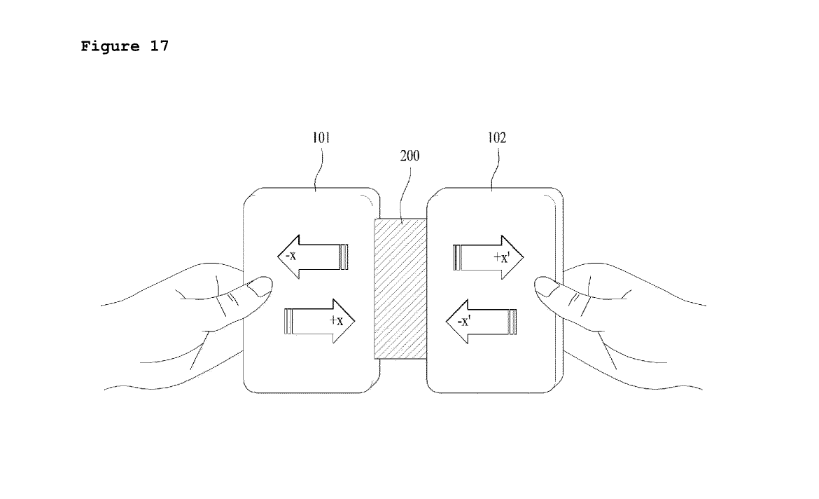

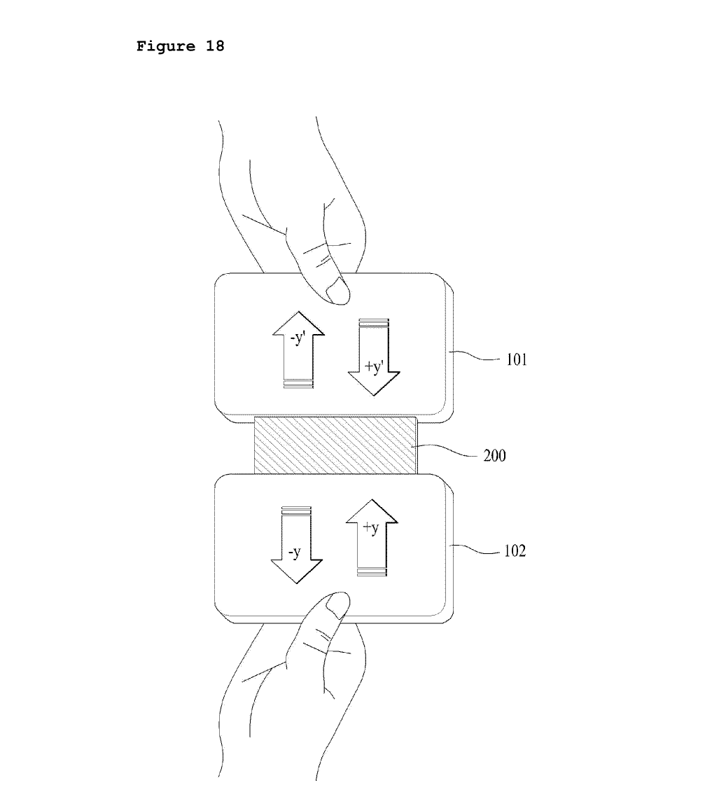

FIGS. 17 and 18 are views showing user input to the display device according to a fourth embodiment of the present invention.

According to the fourth embodiment of the present invention, the user is able to input a user command by moving the first display unit 101 and the second display unit 102 simultaneously.

FIG. 17 shows the case in which the display device is oriented horizontally, and the user inputs a user command by moving the first display unit and the second display unit 102 leftward or rightward simultaneously.

Since the two display units 101 and 102 are connected to each other in parallel, if the user moves the first display unit 101 rightward, the second display unit 102 is simultaneously moved leftward. Similarly, if the user moves the second display unit 102 rightward, the first display unit 101 is simultaneously moved leftward. In this way, the user can move the two display units 101 and 102 closer to or away from each other.

FIG. 18 shows the case in which the display device 10 is oriented vertically, and the user inputs a user command by moving the first display unit and the second display unit 102 upward or downward simultaneously.

As shown in the drawing, the user is able to move the first display unit 101 and the second display unit 102 simultaneously using his/her hand. In this case, the display device 10 recognizes that a user command is input when the positions of the display units 101 and 102 are changed by manual operation of the user.

Although the drawing illustrates the first display unit 101 and the second display unit 102 as being moved upward or downward and leftward or rightward, it will be clearly understood that the display units 101 and 102 are movable in any other direction within 360 degrees.

First, as shown in the drawings, the display device according to the fourth embodiment of the present invention is oriented horizontally or vertically. In this case, the sensor unit 103 measures the horizontal or vertical orientation of the display device 10, generates orientation state information corresponding to the measured result, and transmits the same to the controller 109.

Then, the user displaces the first display unit 101 and the second display unit 102 simultaneously. This displacement of the display units 101 and 102 is sensed by the sensor unit 103. That is, the sensor unit 103 senses the movement directions of the two display units 101 and 102. Then, the sensor unit 103 generates position change information of the two display units 101 and 102, and transmits the same to the controller 109.

The controller 109 provides a user interface of the display units 101 and 102 using the generated orientation state information and position change information.

More specifically, the controller 109 generates a user command corresponding to the generated orientation state information and position change information. Then, the controller 109 operates applications that are being executed on the display units 101 and 102 in response to the generated user command.

Here, the user interface may be configured in various ways by the applications that are being executed on the display units 101 and 102.

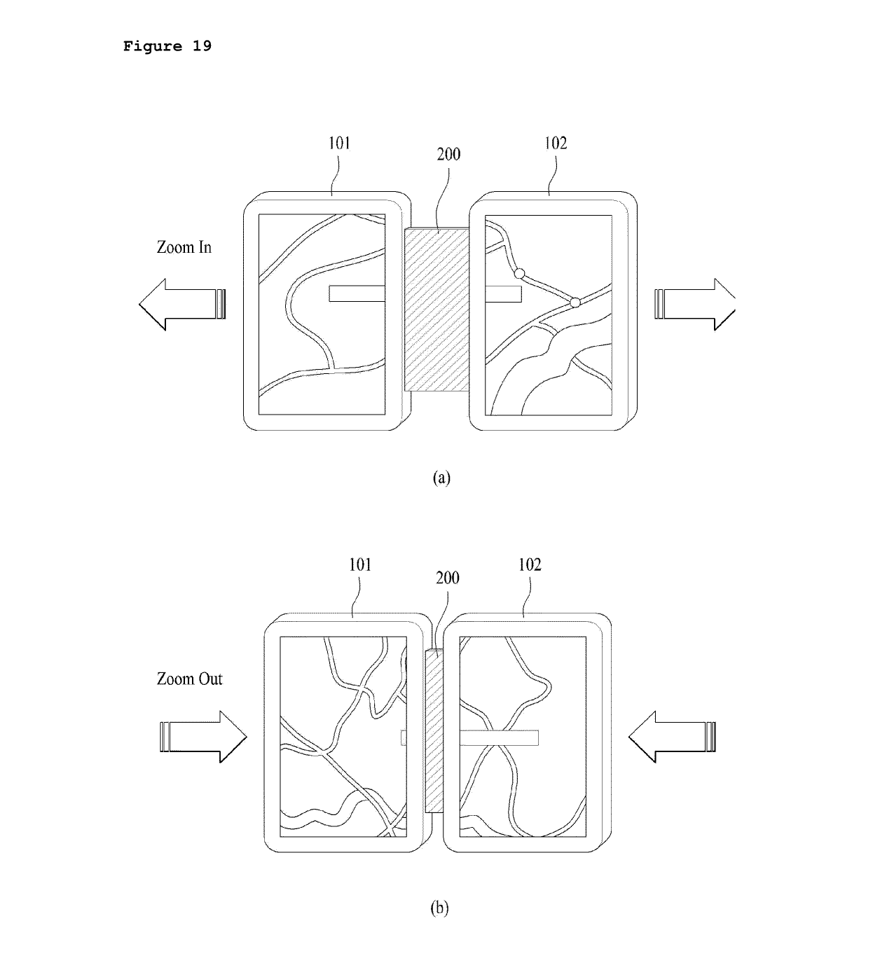

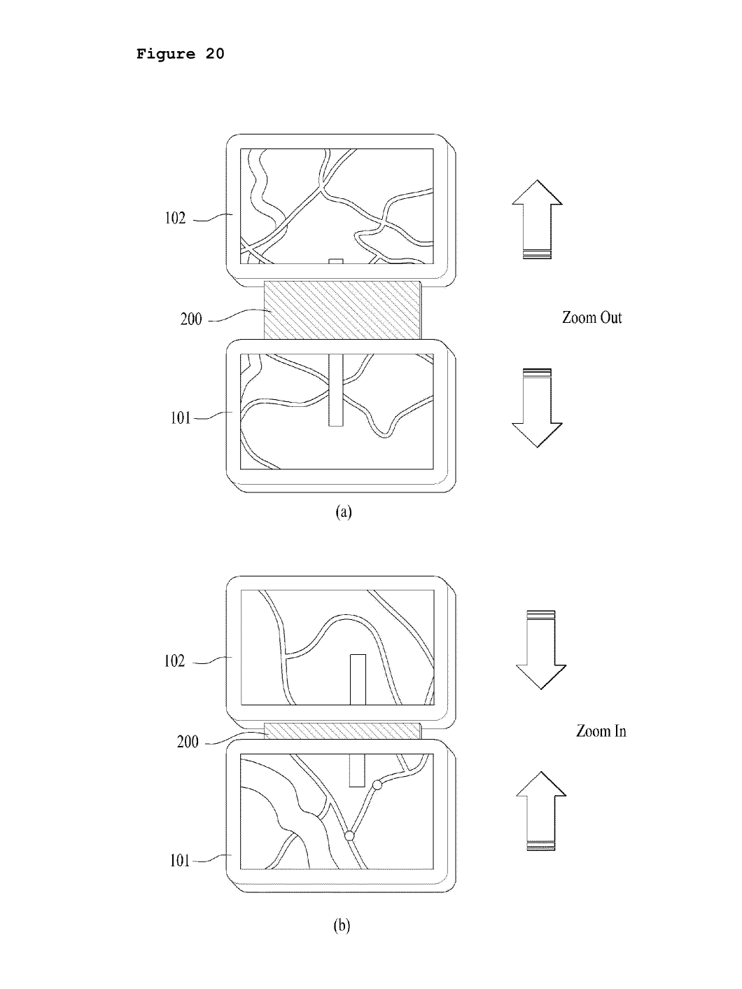

One example of realization of the user interface according to the fourth embodiment of the present invention will be described hereinafter with reference to FIGS. 19 and 20.

FIGS. 19 and 20 are views showing a user interface of the display device according to the fourth embodiment of the present invention.

FIG. 19 shows the case in which the display device 10 is oriented horizontally, the first display unit 101 and the second display unit 102 are executing the same map application, and the user changes the positions of the first display unit 101 and the second display unit 102 simultaneously.

As shown in FIG. 19(a), if the user moves the first display unit 101 leftward and the second display unit 102 rightward, the map application that is being executed on the display units 101 and 102 is zoomed in.

As shown in FIG. 19(b), if the user moves the first display unit 101 rightward and the second display unit 102 leftward, the map application that is being executed on the display units 101 and 102 is zoomed out.

FIG. 20 shows the case in which the display device 10 is oriented vertically, the first display unit 101 and the second display unit 102 are executing the same map application, and the user changes the positions of the first display unit 101 and the second display unit 102 simultaneously.

As shown in FIG. 20(a), if the user moves the first display unit 101 upward and the second display unit 102 downward, the map application that is being executed on the display units 101 and 102 is zoomed out.

As shown in FIG. 20(b), if the user moves the first display unit 101 downward and the second display unit 102 upward, the map application that is being executed on the display units 101 and 102 is zoomed in.

That is, the display device 10 generates a user command using the orientation state information indicating that the display device 10 is oriented vertically or horizontally and the position change information indicating that the two display units 101 and 102 have been displaced by the user. The display device 10 operates the application that is being executed on the display units 101 and 102 in response to the generated user command.

In other words, in the case in which the first display unit 101 and the second display unit 102 are executing the same application, the display device 10 may control both the first display unit 101 and the second display unit 102 using the position change information of the first display unit 101 and the second display unit 102.

In addition, in the case in which the first display unit 101 and the second display unit 102 are executing the same application, the display device 10 may control both the first display unit 101 and the second display unit 102 using the position change information of the first display unit 101 or the second display unit 102. That is, the display device 10 may control both the first display unit 101 and the second display unit 102 using the position change information of only one display unit 101 or 102.

With relation to the above description, in the case in which the user moves the first display unit 101, the second display unit 102 may be moved together. That is, when the user moves the first display unit 101 leftward, the second display unit 102 is relatively moved rightward on the basis of the first display unit 101. Accordingly, it may be necessary for the display device 10 to identify which one of the first display unit 101 and the second display unit 102 is moved by a user input. This is because the display device 10 must identify a target display unit that the user wishes to control.

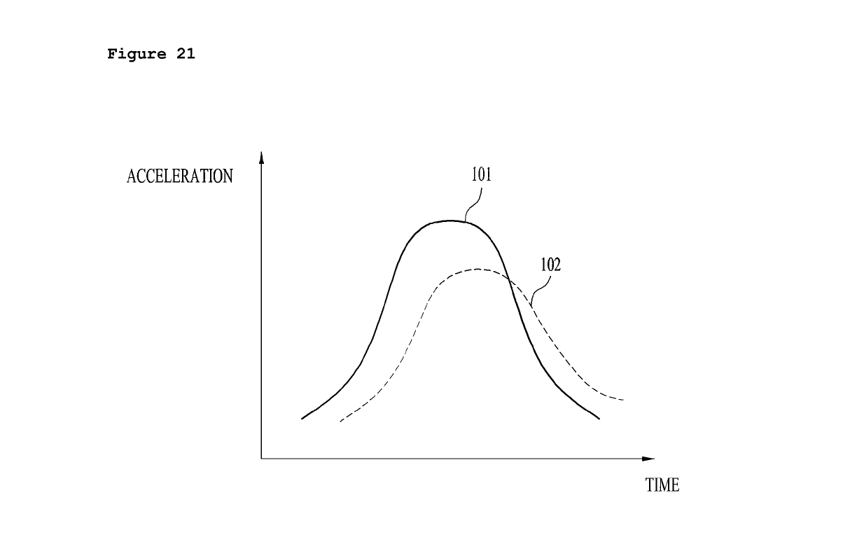

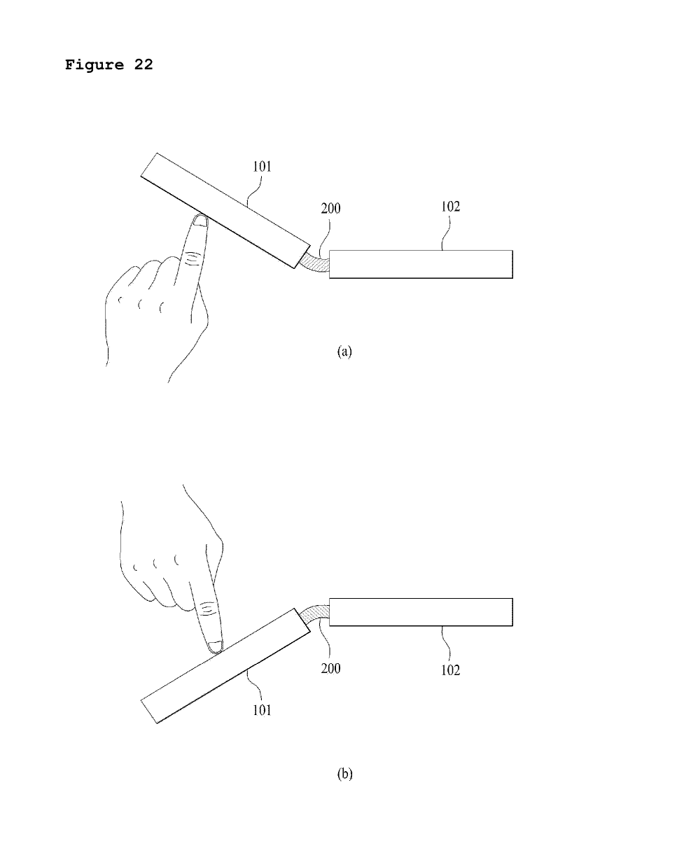

FIGS. 21 and 22 are views showing a method for identifying a target display unit, the position of which has been changed, of the display device 10 of the present invention.

A first method for identifying a target display unit may use acceleration of each display unit 101 or 102.

If the user applies force to a target display unit that the user wishes to control, the target display unit is moved by the force applied by the user. The target display, which is forced by the user, has greater acceleration than the other display unit, and is moved faster than the other display unit. In this way, the display device 10 may identify one of the display units 101 and 102 that is moved at the greater acceleration as the target display unit.

The display device 10 may measure an acceleration value of the moved display unit 101 or 102 using the acceleration sensor of the sensor unit 103 included in the corresponding display unit 101 or 102. That is, the display device 10 identifies the display unit 101 or 102 that moves at the greater acceleration as the target display unit.

FIG. 21 is a view showing the magnitudes of acceleration of the first display unit 101 and the second display unit 102 when the user applies force to the first display unit 101. As shown in the drawing, the magnitude of acceleration of the first display unit 101, to which the user applies force, is greater than that of the second display unit 102. In this case, the display device 10 recognizes the first display unit 101 as the target display unit that the user wishes to control.

Once the display device 10 recognizes the first display unit 101 as the target display unit, the display device 10 controls the first display unit 101 using the position change information and orientation state information of the first display unit 101.

Also, the display device 10 may identify the target display unit using a camera attached to each of the display units 101 and 102. This is because acceleration of each display unit 101 or 102 may be measured based on the change rate of an image captured by the camera of the display unit 101 or 102. That is, the display device 100 may identify one of the display units 101 and 102, the change rate of an image captured by the camera attached thereto is greater than that of the other display unit, as the target display unit.

A second method for identifying a target display unit may use the tilt value of each display unit 101 or 102 with respect to the ground.

The display device 10 may measure the tilt value of each display unit 101 or 102 with respect to the ground using the tilt sensor of the sensor unit 103 included in the corresponding display unit 101 or 102. Also, the display device 10 recognizes the display unit 101 or 102 having a predetermined tilt value or more as the target display unit.

That is, if the user tilts one of the display units 101 and 102, the display device 10 identifies the tilted display unit 101 or 102 as the target display unit. In this case, after the user upwardly or downwardly tilts the display unit 101 or 102 that the user wishes to control as shown in FIG. 22, the display device 10 may control the corresponding display unit 101 or 102. In FIG. 22, the user tilts the first display unit 101 upward or downward, and thus the display device 10 identifies the first display unit 101 as the target display unit.

It will be clearly understood that, on the contrary, the other display unit 101 or 102, which is not tilted, may be identified as the target display unit.

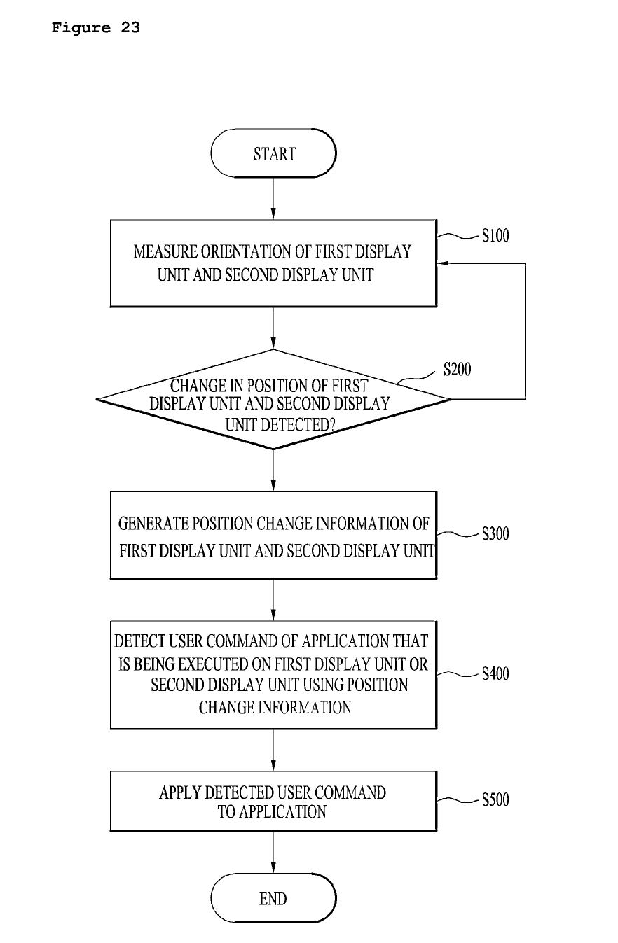

FIG. 23 is a flowchart of a control method of the display device 10 according to an embodiment of the present invention.

First, the sensor unit 103 measures the orientation of the first display unit 101 and the second display unit 102 (S100). That is, the sensor unit 103 measures whether the first display unit 101 and the second display unit 102 are oriented horizontally or vertically and whether or not the two display units 101 and 102 are folded to overlap each other. Then, the sensor unit 103 generates orientation state information of the first display unit 101 and the second display unit 102, and transmits the same to the controller 109.

Subsequently, the sensor unit 103 detects whether the position of the first display unit 101 or the second display unit 102 is changed (S200). If the user changes the position of the first display unit 101 or the second display unit 102, the sensor unit 103 measures and detects the change in the position of the corresponding display unit 101 or 102.

If the position of the first display unit 101 or the second display unit 102 is changed by the user, the sensor unit 103 generates position change information that indicates how much the first display unit 101 or the second display unit 102 is moved in any direction (S300). The sensor unit 103 transmits the generated position change information to the controller 109.

Then, the controller 109 detects a user command of an application that is being executed on the first display unit 101 or the second display unit 102 using the generated orientation state information and position change information (S400).

Finally, the controller 109 applies the detected user command to the application that is being executed (S500).

As is apparent from the above description, a display device and a control method thereof according to the present invention provide an intuitive user interface configured to assist a user in more efficiently controlling a plurality of display units.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A display device comprising:
a first display unit and a second display unit each configured to output an image;
a sensor unit which is configured to generate orientation state information by measuring at least one of relative positions and directions of the first display unit and the second display unit, and which is configured to generate position change information by measuring whether the first display unit or the second display unit is changed in position, wherein the position change information includes a movement direction and a movement distance of the first display unit or the second display unit; and
a controller configured to detect a user command with respect to the first display unit or the second display unit using the orientation state information and the position change information, and control the first display unit or the second display unit in response to the user command.

2. The display device according to claim 1, wherein the orientation state information further includes at least one of whether or not the first display unit and the second display unit are folded to overlap each other and a folding angle of each of the first display unit and the second display unit.

3. The display device according to claim 2, wherein the sensor unit includes:
a first sensor configured to generate the position change information of the first display unit by measuring the change in the position of the first display unit; and
a second sensor configured to generate the position change information of the second display unit by measuring the change in the position of the second display unit.

4. The display device according to claim 1, further comprising a connector configured to connect the first display unit and the second display unit to each other such that the first display unit and the second display unit are movable in a state of being connected to each other.

5. The display device according to claim 4, wherein the connector displaces the first display unit or the second display unit to an original position thereof when the position of the first display unit or the second display unit is changed.

6. The display device according to claim 5,
wherein the sensor unit generates position change time information of the first display unit or the second unit by measuring time consumed for changing the position of the first display unit or the second display unit, and
wherein the controller controls the first display unit or the second display unit using the position change time information.

7. The display device according to claim 4, wherein the sensor unit is included in at least one of the first display unit and the second display unit, or the connector.

8. The display device according to claim 1, wherein the controller controls the first display unit using the position change information of the first display unit, and controls the second display unit using the position change information of the second display unit.

9. The display device according to claim 1, wherein the controller detects a user command with respect to an application that is being displayed on the first display unit or the second display unit using the orientation state information and the position change information, and inputs the user command corresponding to the orientation state information and the position change information to the application.

10. The display device according to claim 9, wherein the controller controls the first display unit and the second display unit using the position change information of the first display unit or the second display unit when the first display unit and the second display unit are displaying the same application.

11. The display device according to claim 9, wherein the controller controls the first display unit and the second display unit using the position change information of the first display unit and the second display unit when the first display unit and the second display unit are displaying the same application.

12. The display device according to claim 1, wherein the controller identifies a target display unit, to which the user command is input, using the acceleration or tilt of the first display unit and the second display unit measured by the sensor unit.

13. A control method of a display device, the method comprising:
generating orientation state information by measuring at least one of relative positions and directions of the first display unit and the second display unit each configured to output an image;
generating position change information by measuring whether the first display unit or the second display unit is changed in position, wherein the position change information includes a movement direction and a movement distance of the first display unit or the second display unit; and
detecting a user command with respect to the first display unit or the second display unit using the orientation state information and the position change information, and controlling the first display unit or the second display unit in response to the user command.

14. The control method according to claim 13, wherein the orientation state information further includes at least one of whether or not the first display unit and the second display unit are folded to overlap each other and a folding angle of each of the first display unit and the second display unit.

15. The control method according to claim 13, wherein the first display unit and the second display unit are connected to each other, and are movable respectively in a state of being connected to each other.

16. The control method according to claim 15, wherein the first display unit or the second display unit, the position of which has been changed, is displaced to an original position thereof.

17. The control method according to claim 16, further comprising generating position change time information of the first display unit or the second unit by measuring time consumed for changing the position of the first display unit or the second display unit,
wherein the control of the display unit includes controlling the first display unit or the second display unit using the position change time information.

18. The control method according to claim 13, wherein the control of the display unit includes controlling the first display unit using the position change information of the first display unit, and controlling the second display unit using the position change information of the second display unit.

19. The control method according to claim 13, wherein the control of the display unit includes detecting a user command with respect to an application that is being displayed on the first display unit or the second display unit using the orientation state information and the position change information, and inputting the user command corresponding to the orientation state information and the position change information to the application.

20. The control method according to claim 19, wherein the control of the display unit includes controlling the first display unit and the second display unit using the position change information of the first display unit or the second display unit when the first display unit and the second display unit are displaying the same application.

21. The control method according to claim 19, wherein the control of the display unit includes controlling the first display unit and the second display unit using the position change information of the first display unit and the second display unit when the first display unit and the second display unit are displaying the same application.

22. The control method according to claim 13, wherein the control of the display unit includes identifying a target display unit, to which the user command is input, using the acceleration or tilt of the first display unit and the second display unit.
